(19) United States
(12) Patent Application Publication
(10) Pub. No.: US 2010/0189302 A1
(43) Pub. Date: Jul. 29, 2010

(54) DATA RECORDER

(75) Inventor: Barry Charles Chamberlain, Salisbury (GB)

Correspondence Address: OLIFF & BERRIDGE, PLC, P.O. BOX 320850, ALEXANDRIA, VA, 22320-4850, US

(73) Assignee: QINETIQ LIMITED, LONDON (GB)

(21) Appl. No.: 12/600,367

(22) PCT Filed: May 22, 2008
(86) PCT No.: PCT/GB08/01733

§ 371 Date: Nov. 16, 2009

(30) Foreign Application Priority Data
Jun. 5, 2007 (GB) 0710685.9

(51) Int. Cl. H04R 1/02

(52) U.S. Cl. 381/375; 381/376

(57) ABSTRACT

A head mounted data storage device comprising an audio receiver for receiving audio signals, a solid state memory for storing received signals, and a power source for providing power to said device. The unit is self contained and adapted to be mounted about the head of a user, typically on a headset or integrated within the shell of a helmet.

This invention relates to a helmet mounted data storage device, and particularly, but not exclusively to cockpit voice recorders.

Cockpit voice recorders (CVR) are commonly installed in large commercial aircraft to record the audio environment of the flightdeck. Such information can be used in the investigation of accidents. Like the Flight Data Recorder (FDR) or ‘black box’, the CVR is typically mounted in the empennage or tail section of an aircraft to maximise survivability in the event of a crash, and the two units are increasingly integrated.

Not all aircraft are equipped with CVRs however, and the lack of a CVR on older aircraft and even new, smaller aircraft including helicopters can create difficulties when investigating accidents or other events where other information is scarce. The retro-fitting of crash protected recording equipment into an aircraft or other vehicle is however costly and intrusion into the existing aircraft systems to fit such a device is undesirable.

It is therefore an object of aspects of the present invention to ameliorate or overcome these deficiencies.

Accordingly, a first aspect of the present invention provides a head mounted data storage device comprising an audio receiver for receiving audio signals, a solid state memory for storing received signals, and a power source for providing power to said device, wherein said input, said memory and said power source are contained within a casing, and wherein said casing is adapted to be mounted about the head of a user.

In this way, an audio data storage capability is provided with little or more likely no modification to a vehicle or aircraft or other user environment. The unit can be a self contained, stand alone device and sufficiently small and lightweight to be head mounted. In the case of a multi-crew aircraft or vehicle, multiple recordings improves the probability of recovering sufficient information to investigate any possible incident or event.

The device may be mounted on a headset, but in a particularly preferred embodiment is mounted on a helmet, preferably within the outer casing of the helmet. In such an embodiment, the device is afforded the protection of the helmet and has a greatly increased chance of survival and recovery, as the helmet will often remain on the wearer in the event of a crash.

The audio receiver will typically be embodied as a pick up coil for receiving signals from a microphone and/or earphones of a user, and in this way, the recorder unit and pick-up is non intrusive (not electrically connected) to the audio circuit being monitored. However, embodiments may alternatively or additionally comprise a dedicated microphone. More advanced embodiments may allow multiple channels for recording from multiple receivers. For example, a first channel may receive data from a pickup coupled to the user's earphones, while a second channel receives data from microphone arranged to capture ambient noise.

The power source will typically be a rechargeable cell, and in embodiments where a pick up is employed as a receiver, the pickup can additionally be used to draw power inductively from a base unit when not in use/during a charge cycle.

It may be desirable in more sophisticated embodiments to provide for recording of additional data types. One particularly useful data type is acceleration data, and accordingly embodiments may be provided with one or more accelerometers to provide such data. It will be understood that because of the head mounted nature of the device, acceleration data could be particularly useful in determining the forces acting on the head of a user, both after an event such as a crash, and in normal operation. Such specific user data would typically not be available even where an aircraft or other vehicle has accelerometers mounted in other locations. Preferably a tri-axial accelerometer arrangement is used to provide data in three axes.

Other useful types of data which could be stored include image or video data in embodiments where an image capture device is incorporated. Again because the device is head mounted, image data can be recorded representing the user's perspective, which is typically not fixed.

The invention extends to methods, apparatus and/or use substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:

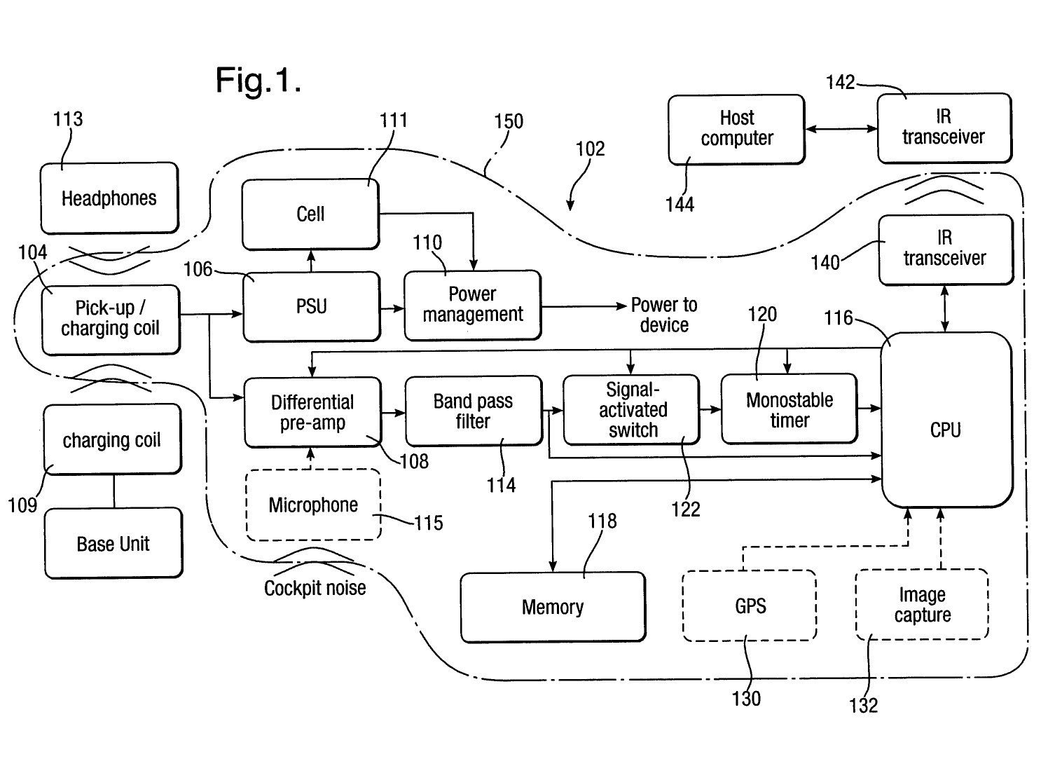

FIG. 1 is a schematic arrangement of a device according to an aspect of the invention

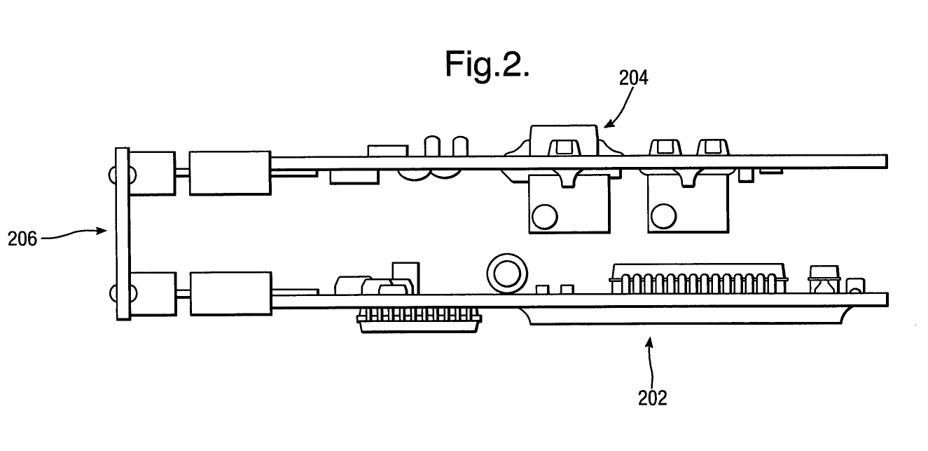

FIG. 2 illustrates control electronics and memory boards

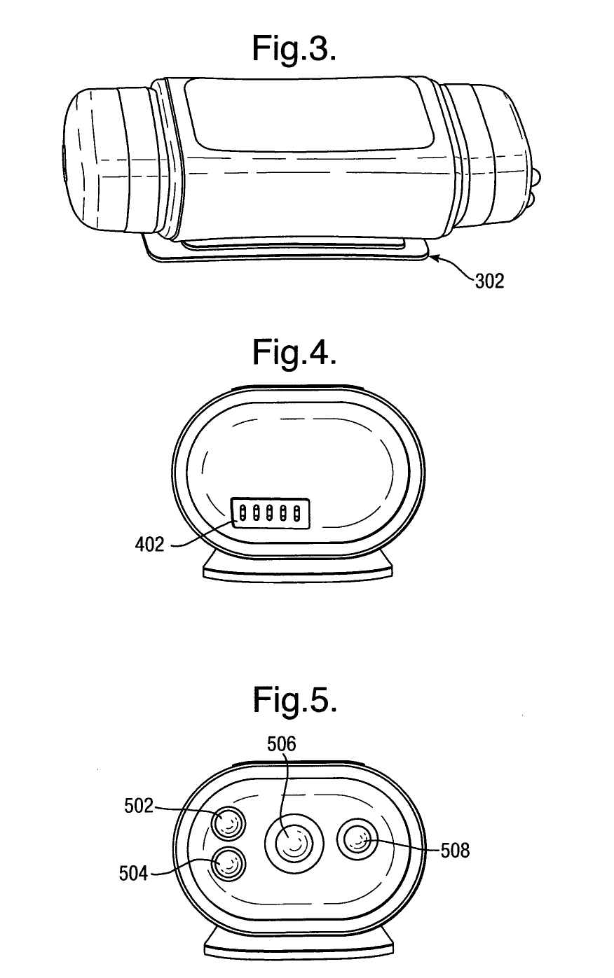

FIGS. 3, 4 and 5 are views of a device according to an aspect of the invention

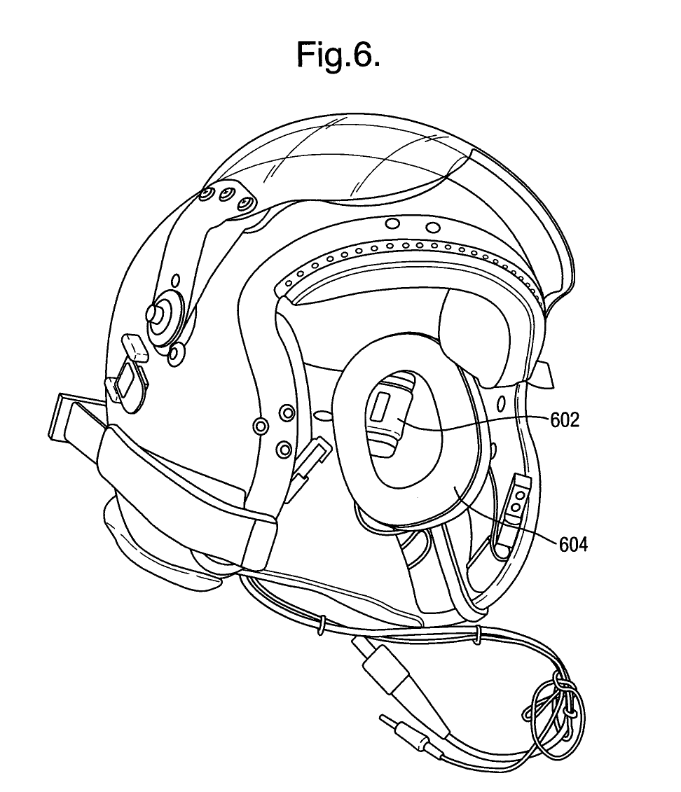

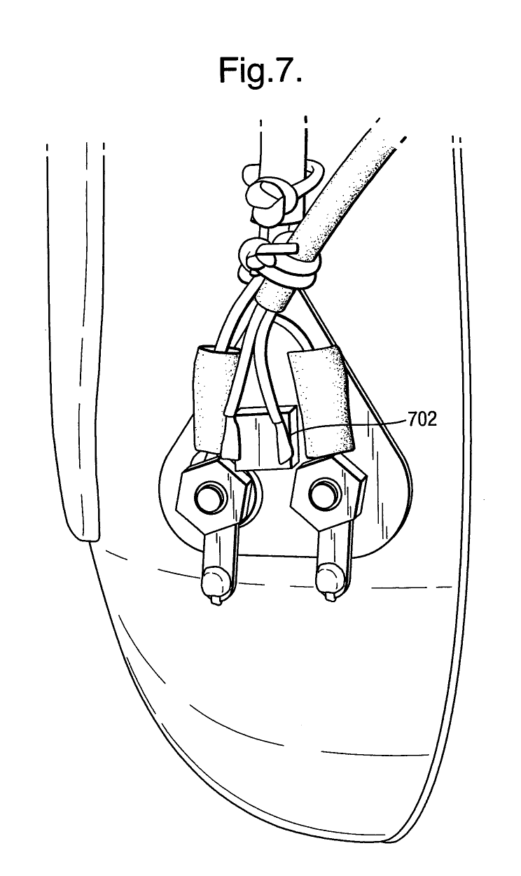

FIGS. 6 and 7 show examples of a helmet embodying aspects of the invention.

With reference to FIG. 1, a device designated generally by numeral 102 includes a pick up coil 104 which provides an input for both power supply unit 106 and differential pre-amplifier 108. Considering first the power supply unit, when the device is in a charging cycle, the pick up coil receives power inductively from a base unit having a charging coil 109, and feeds power supply unit 106. Power management unit 110 preferentially selects power from the supply unit 106 while in this mode, and unit 106 simultaneously charges rechargeable cell 111.

When power from a base unit is not being received (ie in an operation cycle) the power management unit selects the rechargeable cell as the power source for the device. In such an operation cycle, the pick up coil couples electromagnetic energy from a microphone or earphones 113 to differential pre-amplifier 108 as a low level signal. Acoustic microphone 115 is shown dashed line indicating that in certain embodiments, provision may additionally or alternatively be made for an input to amplifier 106 from an acoustic transducer, possibly by the addition of a second audio channel. Amplified signals are band pass filtered at 114 and provided as the audio input to CPU 116.

The CPU is connected to a flash memory 118 and stores the filtered audio input under the control of a monostable or one-shot timer 120. Timer 120 is activated by a signal activated switch 122, which triggers when an audio input from filter 114 exceeds a threshold value. Thus when the filtered audio signal exceeds the threshold value, audio is stored to memory 118 for the duration determined by timer 120. Alternatively or additionally recording can be made to cease after a pre-determined time, 5 minutes for example, with no signal /electrical activity being present in the circuit being monitored. The CPU intelligently provides active gain control to amplifier 116, and threshold and duration control to switch 122 and timer 120 respectively, such that recording commences only when there is electrical activity in the pick up coil, and continues until a short time after activity ceases.

In the illustrated embodiment, the capacity of the memory is 64 Mbytes with five recording quality settings available giving a recording duration from 1.6 hours (before overwriting oldest information) at highest quality (uncompressed) to 9.3 hours for extra long play (where significant information compression is used). Capacities of up to 512 Mbytes are currently available which have the required size envelope, and it is envisaged that higher capacities still will become available.

GPS module 130 and video capture module 132 are shown dashed line to indicate that provision may be made for GPS data and image and/or video inputs to CPU 116.

A transceiver 140 can receive interrogation commands from an interrogating transceiver 142, typically linked to a host computer 144. In response to such a command, the CPU reads saved audio data from memory 118 and sends it to transceiver 140 for onward transmission to transceiver 142. Such a transceiver link can also be used for configuring the recorder e.g. audio recording quality, gain setting, password, date/time etce In such embodiments, a multi-way connector strip 402 (referred to below) is not required.

The device is encapsulated in a housing or casing designated schematically 150. The housing is preferably formed by encapsulation of the device in a clear or slightly opaque potting compound, with no external connections required. The potting compound can be made dissolvable in a given solvent such that the components can be accessed if required. Alternatively the device can be inserted in a more conventional cover. The device is therefore stand-alone and self contained.

FIG. 2 shows the assembled electronics comprising a first PCB 202 including a flash memory, and a second PCB 204 including control electronics. The first PCB can be a COTS component, for example an OEM card based on a PIC™ microcontroller with integral 10-bit 8-channel A/D having external flash memory. The two boards are joined by a bridging unit 206, however it would be equally possible to configure the electronics on a single board.

FIG. 3 shows a perspective view, and FIGS. 4 and 5 end views of an example of an encapsulated device. The dimensions of the device of FIG. 3 are 67 mm×25 mm×16 mm and weight is approximately 24 grams. A Velcro strip 302 is attached to the base of the device to assist location on a headset or inside a helmet for example.

In FIG. 5, LEDs 502 and 504 on the end cap indicate recorder start/stop transitions & recorder in operation (‘heartbeat’), this end cap also houses connectors 506, 508 for an audio pick-up and battery cell charging. In FIG. 4, the multi-way connector strip 402 is used for programming recorder and downloading recorded information via the USB on a laptop computer. As noted above however, not all embodiments require external connections.

FIG. 6 shows a helmet according to an embodiment of the invention, including a data recording device. The device 602 is sufficiently small to be located within the earshell 604 of the helmet, sufficiently close to the earpiece to give electromagnetic coupling with the pick-up coil. In this position, the device will be protected from impact by its own light weight enclosure and will be internal to the helmet and therefore benefit from the protection offered by the helmet itself. The electronics may be potted in wax or potting compound to protect against submergence in the event of an accident over water. A layer of foam may be placed over the recorder, for comfort purposes for the helmet wearer, if required.

In an alternative arrangement the earshell of a helmet or headset is adapted to receive the present device in a dedicated mounting, which may for example be a ‘slide and lock’ fixing arrangement, the housing or casing of the device then having mounting features to allow simple attachment and detachment as required. An advantage of this arrangement is that the coupling distance between the earpiece and the pick up coil is maintained constant.

A further alternative is for the device to be mounted in the lower part of a helmet which protects the back of the wearer's head/neck with a flying lead for the pick up, shown as 702 in FIG. 7, located non-intrusively on the side of the earpiece shell.

It will be understood that the present invention has been described above purely by way of example, and modification of detail can be made within the scope of the invention.

Although the invention has been described principally in relation to cockpit voice recorders, other applications where helmets or headsets are worn, such as other types of vehicle and police forces, are envisaged.

Each feature disclosed in the description, and (where appropriate) the claims and drawings may be provided independently or in any appropriate combination.

1. A head mounted data storage device comprising an audio receiver for receiving audio signals, a solid state memory for storing received signals, and a power source for providing power to said device, wherein said input, said memory and said power source are contained within a casing, and wherein said casing is adapted to be mounted about the head of a user.

2. A device according to claim 1, adapted to be mounted on a headset.

3. A device according to claim 1, adapted to be mounted on a helmet.

4. A device according to claim 3, wherein the device is adapted to be mounted within the outer casing of a helmet.

5. A device according to claim 1, wherein said receiver comprises a pick up coil adapted to receive electrical audio signals.

6. A device according to claim 1, wherein said receiver comprises a microphone adapted to receive acoustic audio signals.

7. A device according to claim 1, wherein storing to memory commences when said received signal exceeds a threshold value.

8. A device according to claim 7, wherein storing to memory continues for a predetermined minimum duration.

9. A device according to claim 1, wherein said power source comprises a rechargeable cell.

10. A device according to claim 5, wherein said pick up is adapted to receive power inductively from a base station, and to charge said rechargeable cell.

11. A device according to claim 1, wherein said device additionally includes a transceiver for inputting configuration data and/or outputting stored data.

12. A device according to claim 11, wherein said transceiver is infra red.

13. A device according to claim 1, wherein said device comprises more than one audio channel.

14. A device according to claim 13, wherein a first audio channel receives audio data via a pick up coil, and a second audio channel receives ambient audio signals via a microphone.

15. A device according to claim 1, wherein said device further comprises an accelerometer, and wherein acceleration data is stored in said memory.

16. A device according to claim 15, wherein the device includes three accelerometers to provide tri-axial acceleration data.

17. A device according to claim 1, wherein said device further comprises an image capture input, and wherein images and/or video are stored in said memory.

18. A device according to claim 1, wherein said device further comprises a satellite positioning input, and wherein positional information is stored in said memory.

19. A helmet or headset including a data storage device according to claim 1.

20. A helmet or headset according to claim 19, wherein said device is attached to said helmet or headset by a releasable fastening arrangement.
